(19) United States
(12) Patent Application Publication
(10) Pub. No.: US 2012/0125770 A1
(43) Pub. Date: May 24, 2012

(54) HYDROGEN GAS SENSOR

(75) Inventors: Shuji Harada, Niigata-shi (JP); Tatsuya Ishiduka, Niigata-shi (JP); Tsuneo Nakamura, Niigata-shi (JP)

(73) Assignee: NATIONAL UNIVERSITY CORPORATION NIIGATA UNIVERSITY, Niigata-shi, Niigata (JP)

(21) Appl. No.: 13/388,343

(22) PCT Filed: May 21, 2010
(86) PCT No.: PCT/JP2010/003445

§ 371 Date: Feb. 1, 2012

(51) Int. Cl. G01N 27/407; G01N 27/26

(52) U.S. Cl. 204/408; 204/431; 204/427

(57) ABSTRACT

A hydrogen gas sensor comprising a detection electrode, a reference electrode, and an electrolyte contacting with these electrodes, in which the reference electrode and the detection electrode are composed of a material having a property that hydrogen molecule doesn't voluntarily dissociate into atomic hydrogen on a surface of the electrode in Standard State such as nickel, titanium, copper, tungsten and the like, in which hydrogen gas is detected by an electromotive force generated between the reference electrode and the detection electrode while at least the detection electrode is maintained at a temperature not less than a temperature that hydrogen molecule begins to dissociate into atomic hydrogen voluntarily on the surface of the detection electrode.

### TECHNICAL FIELD

The present invention relates to a hydrogen gas sensor. More particularly, the present invention relates to a hydrogen gas sensor suitable for a usage such as detection of hydrogen concentration in a hydrogen electrode side cell of a hydrogen-fuel cell to evaluate operation status or fuel efficiency of the hydrogen-fuel cell.

### BACKGROUND ART

A hydrogen gas sensor is employed to ensure safety in a hydrogen energy utilization system as typified by a fuel cell or a hydrogen-fueled engine and in a hydrogen station where hydrogen is manufactured, transported, stored, filled, and the like. An optical sensor, a contact combustion sensor, a semiconductor sensor, an electromotive force (EMF) sensor, a current detection (cell type) sensor, and a pressure change mechanical sensor using properties of hydrogen adsorption or hydrogen absorption, a MOS capacitor sensor and the like are known as the hydrogen gas sensor. Among them, the EMF hydrogen gas sensor has advantages that required time for hydrogen detection is short, sensitivity is not easily influenced by an outside environment such as temperature, humidity or so on, miniaturization is easy and manufacturing cost is low since structure is simple, and self-checking of a breakdown or abnormality of the sensor can be conducted since an inherent electromotive force value is indicated even at hydrogen gas concentration of zero. It is considered that the advantages in the EMF hydrogen gas sensor meet a need of ensuring the safety of the hydrogen energy utilization system.

As the EMF hydrogen gas sensor, for example, described in PATENT LITERATURE 1 is a hydrogen gas sensor comprising a first electrode, a second electrode and an electrolyte contacting with the electrodes, wherein the first electrode and second electrode are composed of different materials each other in chemical potential for hydrogen gas, and the first electrode comprises relatively high chemical potential material and the second electrode comprises relatively low chemical potential material, wherein hydrogen gas can be detected by an electromotive force generated between the electrodes. The first electrode is made of material such as platinum, platinum alloy, palladium, palladium alloy and the like. The second electrode is made of material such as nickel, nickel alloy, titanium, titanium alloy, copper, copper alloy, iron, iron alloy, aluminum, and aluminum alloy or organic electrically-conductive materials. The electrolyte is made of material such as phosphotungstic acid and the like.

PATENT LITERATURE 2 discloses a hydrogen gas sensor comprising a solid electrolyte, and a first electrode and a second electrode formed on a surface of the solid electrolyte, wherein the solid electrolyte comprises an ion conductor conducting protons and oxide ions, the first electrode is composed of a material having a function to prevent oxygen ionization, and the second electrode is composed of a material having catalytic action with respect to oxidation of hydrogen, wherein measurement of a voltage between the first electrode and the second electrode determines hydrogen concentration. The first electrode comprises at least one element selected from the group consisting of aluminum, copper, and nickel. The second electrode comprises at least one element selected from the group consisting of platinum, gold, silver, palladium, and ruthenium. Barium-cerium-based oxide is used as the solid electrolyte.

Moreover, PATENT LITERATURE 2 discloses that a platinum anode and a platinum cathode are placed so as to come in contact with the solid electrolyte composed of barium-cerium-based oxide, and any one of the anode and cathode is heated or cooled so as to be different from each other in temperature of the electrodes. This sensor is a constant electrolysis fixed type hydrogen sensor, in which increase or decrease of a current in an external circuit detects a level of hydrogen gas concentration. In the constant electrolysis fixed type hydrogen sensor, a surface area of the electrodes should be enlarged in order to improve detection sensitivity. Moreover, the platinum used for the electrodes is a material having a property that hydrogen molecule voluntarily dissociates into atomic hydrogen on the surface of the electrodes in Standard State.

### PRIOR ART LIST

### Patent Literatures

PATENT LITERATURE 1: WO 2005/080957 A1

PATENT LITERATURE 2: JP 2003-166972 A

### SUMMARY OF THE INVENTION

### Problems to be Resolved by the Invention

A conventional EMF hydrogen gas sensor uses a detection electrode composed of a material having a property that hydrogen molecule voluntarily dissociates into atomic hydrogen on a surface of the electrode in Standard State. And, in the EMF hydrogen gas sensor, since an electromotive force varies in proportion to the logarithm of hydrogen gas concentration, an electromotive force variation against a concentration variation is large and highly sensitive within a low concentration range. However, the electromotive force variation against the concentration variation is small and lowly sensitive within a high concentration range. Then, an object of the present invention is to provide an EMF hydrogen gas sensor in which the electromotive force varies in proportion to the hydrogen gas concentration within a range from low concentration to high concentration.

### Means of Solving the Problems

The present inventors studied zealously to solve the above-mentioned problem. A detection electrode and a reference electrode were made of a material having a property that hydrogen molecule doesn't voluntarily dissociate into atomic hydrogen on a surface of the electrodes in Standard State, for instance, nickel, silver, tungsten and the like, and the detection electrode was maintained at a temperature of not less than a temperature that hydrogen molecule begins to voluntarily dissociate into atomic hydrogen on a surface of the detection electrode. As a result, the present inventors found that a value of electromotive force generated between the reference electrode and the detection electrode varies in proportion to hydrogen gas concentration within a range from a low concentration to high concentration. The present invention came to complete by studying repeatedly further on a basis of this finding.

That is, the present invention includes followings.
(1) A hydrogen gas sensor comprising: a detection electrode, a reference electrode, and an electrolyte contacting with these electrodes; wherein the reference electrode and the detection electrode are composed of a material having a property that hydrogen molecule doesn't voluntarily dissociate into atomic hydrogen on a surface of the electrodes in Standard State; wherein hydrogen gas is detected by an electromotive force generated between the reference electrode and the detection electrode while at least the detection electrode is maintained at a temperature of not lower than a temperature that hydrogen molecule begins to dissociate into atomic hydrogen voluntarily on a surface of the detection electrode.
(2) The hydrogen gas sensor according to the (1), wherein the detection electrode is composed of the material being T₁ in the temperature that hydrogen molecule begins to dissociate into atomic hydrogen voluntarily on a surface of the detection electrode in which T₁ is higher than Standard State, and wherein the reference electrode is composed of the material being T₂ in a temperature that hydrogen molecule begins to dissociate into atomic hydrogen voluntarily on a surface of the reference electrode in which T₂ is higher than T₁.
(3) The hydrogen gas sensor according to the (2), wherein the reference electrode and the detection electrode are maintained at a temperature T_{S} between T₁ and T₂.
(4) The hydrogen gas sensor according to the (1) or (2), wherein a temperature of the detection electrode is higher than a temperature of the reference electrode.
(5) The hydrogen gas sensor according to the (1), wherein the reference electrode and the detection electrode are composed of the material being T_{O} in a temperature that hydrogen molecule begins to dissociate into atomic hydrogen voluntarily on a surface of the electrodes in which T_{O} is higher than Standard State, wherein the reference electrode is maintained at a temperature T_{R} lower than T_{O}, and the detection electrode is maintained at a temperature T_{D} higher than T_{O}.
(6) The hydrogen gas sensor according to any one of the (1) to (5), wherein the detection electrode and the reference electrode are composed of the material having an electromotive force of less than 0.8 V in a cell composed of H₂(−)|50 mol/m³ H₂SO₄|the material (+) on Standard State.
(7) The hydrogen gas sensor according to any one of the (1) to (5), wherein the detection electrode and the reference electrode are composed of the at least one material selected from the group consisting of simple substance metal of tungsten, nickel, titanium, copper, silver, or aluminum; alloy comprising tungsten, nickel, titanium, copper, silver, and/or aluminum; metal hydride comprising tungsten, nickel, titanium, copper, silver and/or aluminum; and organic electrically conductive material.
(8) The hydrogen gas sensor according to any one of the (1) to (5), wherein the reference electrode is composed of metal hydride.
(9) The hydrogen gas sensor according to any one of the (1) to (8), wherein the electrolyte is a solid electrolyte.
(10) The hydrogen gas sensor according to any one of the (1) to (8), wherein the electrolyte is composed of phosphotungstic acid or phosphomolybdic acid.
(11) The hydrogen gas sensor according to any one of the (1) to (10), further comprising a unit for controlling each temperature of the reference electrode and the detection electrode.
(12) The hydrogen gas sensor according to any one of the (1) to (11), further comprising a temperature compensation unit.
(12) The hydrogen energy utilization system comprising the hydrogen gas sensor according to any one of the (1) to (12).

Hereinafter, means employed in the present invention to solve the above-mentioned problem is explained. A hydrogen gas sensor in the present invention comprises a detection electrode, a reference electrode, and an electrolyte. The detection electrode and the reference electrode are alienated from each other and the electrodes contact with the electrolyte.

In the hydrogen gas sensor of the present invention, the detection electrode and the reference electrode are made of a material having a property that hydrogen molecule doesn't voluntarily dissociate into atomic hydrogen on a surface of the electrodes in Standard State. The material used for the detection electrode and the reference electrode may be identical mutually and may be different mutually as long as the material has a property that hydrogen molecule doesn't voluntarily dissociate into atomic hydrogen on a surface of the electrodes in Standard State. “Standard State” means a state of a normal temperature and normal pressure, and specifically means a state of 25° C. (298.15K) and 1 atm (101.325 kPa). In the conventional EMF hydrogen gas sensor, a reference electrode employs a material having a property that hydrogen molecule doesn't voluntarily dissociate into atomic hydrogen on a surface of the reference electrode in Standard State, such as nickel, and a detection electrode employs a material having a property that hydrogen molecule voluntarily dissociates into atomic hydrogen on a surface of the detection electrode in Standard State, such as platinum. Therefore, it can be understood that the hydrogen gas sensor of the present invention has peculiar framework compared with the conventional EMF hydrogen gas sensor having a framework that contact between hydrogen gas and the detection electrode in Standard State allows the detection electrode to vary an electromotive force.

And, in the hydrogen gas sensor of the present invention, detection of hydrogen gas is carried out while at least the detection electrode is maintained at a temperature of not lower than a temperature that hydrogen molecule begins to dissociate into atomic hydrogen voluntarily on a surface of the detection electrode. And, hydrogen gas contacting with the detection electrode in that temperature state dissociates into atomic hydrogen and the dissociation results in changing an electromotive force of the detection electrode. In the case that the detection electrode and the reference electrode employ same material, a temperature of the detection electrode is preferably higher than a temperature of the reference electrode. In the case that the detection electrode and the reference electrode employ different materials, a temperature of the detection electrode may be the same as a temperature of the reference electrode or may be different from a temperature of the reference electrode. In the hydrogen gas sensor of the present invention, by the above-mentioned framework, an electromotive force varies in proportional to hydrogen gas concentration within the range from low concentration to high concentration.

On the other hand, a temperature of the reference electrode is not especially limited. For example, in the case that the reference electrode is maintained at a temperature of lower than a temperature that hydrogen molecule begins to dissociate into atomic hydrogen voluntarily on a surface of the reference electrode, the dissociation of the hydrogen gas doesn't occur at the reference electrode. Therefore, only an electromotive force variation of the detection electrode generated by hydrogen gas dissociation at the detection electrode is detected as variation of a potential difference between the two electrodes. In the case that the reference electrode is maintained at a temperature not lower than the temperature that hydrogen molecule begins to dissociate into atomic hydrogen voluntarily on the surface of the reference electrode, the dissociation of the hydrogen gas also occurs at the reference electrode. Therefore, the sum of an electromotive force variation at the reference electrode and the electromotive force variation at the detection electrode is detected as variation of the potential difference between the two electrodes. Moreover, a temperature that hydrogen molecule begins to dissociate into atomic hydrogen voluntarily on a surface of an electrode depends on a material used for the electrode. Therefore, a relation between hydrogen concentration and electromotive force can be arbitrarily adjusted by selecting a material of the electrode or setting a temperature of the electrode properly.

A temperature controller of the detection electrode and the reference electrode is not especially limited. For example, a heater or a cooler may be placed near the electrodes, or the electrodes may be covered with a meshed heater or cooler. Moreover, a temperature of the electrodes is measured with the temperature sensor, and then an electric power to be supplied to the heater and the like can be controlled by a variable resistor on the basis of that measurement to maintain the desired temperature of the electrodes. Since the electromotive force between the detection electrode and the reference electrode might change depending on a temperature, the temperature is preferably controlled to keep constant as much as possible. Moreover, the hydrogen gas sensor of the present invention preferably comprises a temperature compensation unit. For example, two hydrogen gas sensors a and b according to the present invention are prepared. The sensors are placed in the same temperature environment. The hydrogen gas sensor b is contacted with inert gas and the hydrogen gas sensor a is contacted with sample gas containing hydrogen. EMF values of both hydrogen gas sensors are determined. And then, a temperature compensation can be done by subtracting the EMF value of hydrogen gas sensor b from the EMF value of hydrogen gas sensor a to obtain the variation of the EMF value resulting from only a contact with the hydrogen gas.

One preferable embodiment of the present invention includes a hydrogen gas sensor comprising a detection electrode composed of a material being T₁ in a temperature that hydrogen molecule begins to dissociate into atomic hydrogen voluntarily on a surface of the electrode in which T₁ is higher than Standard State and a reference electrode composed of a material being T₂ in a temperature that hydrogen molecule begins to dissociate into atomic hydrogen voluntarily on a surface of the electrode in which T₂ is higher than T₁. In the hydrogen gas sensor having such framework, the reference electrode and the detection electrode are preferably maintained at a temperature T_{S} between T₁ and T₂. In a state maintained at the temperature T_{S}, the electromotive force variation generated only by a dissociation of hydrogen gas at the detection electrode is detected as a variation of potential difference between the two electrodes since the dissociation of the hydrogen gas doesn't occur at the reference electrode.

Another preferable embodiment of the present invention includes a hydrogen gas sensor comprising a detection electrode and a reference electrode composed of a material being T_{O} in a temperature that hydrogen molecule begins to dissociate into atomic hydrogen voluntarily on a surface of the electrodes in which T_{O} is higher than Standard State. In the hydrogen gas sensor having such framework, it is preferable that the reference electrode is maintained at a temperature T_{R} which is lower than T_{O} and the detection electrode is maintained at temperature T_{D} which is higher than T_{O}. In a state maintained at such the temperatures, an electromotive force variation generated only by a dissociation of hydrogen gas at the detection electrode is detected as a variation of a potential difference between the two electrodes since the dissociation of hydrogen gas doesn't occur at the reference electrode.

A material used for the detection electrode and the reference electrode is a material having a property that hydrogen molecule doesn't voluntarily dissociate into atomic hydrogen on a surface of the electrodes in Standard State. As for the material, a material that doesn't react with the electrolyte is preferable. A preferable material used for the detection electrode and the reference electrode is preferably less than 0.8V, more preferably not less than 0V and less than 0.8V in an electromotive force in a cell composed of H₂(−)|50 mol/m³ H₂SO₄|the material (+) on Standard State. Specifically examples of the material include simple substance metal of copper, silver, tungsten, molybdenum, zirconium, cobalt, nickel, tantalum, titanium, niobium, aluminum or vanadium; alloy or metallic compound containing any one of or at least two of these metals; organic electrically conducting material; and composite material thereof. Among these, simple substance metal of tungsten, nickel, titanium, copper, silver, or aluminum; alloy containing tungsten, nickel, titanium, copper, silver and/or aluminum; metal hydride containing tungsten, nickel, titanium, copper, silver and/or aluminum; and/or organic electrically conductive material; and composite material thereof are more preferred. A material composed of the metal hydride is preferably used for the reference electrode. Using of the metal hydride can give a reference electrode which is stable toward a change in hydrogen concentration. A material having a property that hydrogen molecule voluntarily dissociates into atomic hydrogen on a surface of the electrodes in Standard State, such as platinum, gold, palladium and the like may be contained in the above-mentioned material as long as the property that hydrogen molecule doesn't voluntarily dissociate into atomic hydrogen on the surface of the electrodes in Standard State is kept.

The electrolyte used for the hydrogen gas sensor of the present invention may be liquid, gel, or solid. The solid electrolyte is preferable from the viewpoint of stability and easiness to handle. Examples of the solid electrolyte include phosphotungstic acid and phosphomolybdic acid; perovskite type oxides such as BaCe_{0.9}Y_{0.1}O_{3-α}, SrZr_{0.9}Y_{0.1}O_{3-α}, and the like; solid polymer electrolyte as typified by perfluoro sulfonic acid resins such as Brand name Nafion® produced by DoPont and the like. Among these, phosphotungstic acid or phosphomolybdic acid is preferable from a viewpoint of low-cost. The solid polymer electrolyte is preferable from a viewpoint of relatively-high resistance to a humid environment. Since phosphotungstic acid or phosphomolybdic acid is usually supplied in powdery state, the solid electrolyte can be prepared by a compression molding method as described in WO2005/80957, a fusion-solidification method, or the like. Moreover, strength of the electrolyte layer and adhesiveness to the electrode can be increased by impregnating the electrolyte with a structural reinforcement material such as a glass wool.

### Advantageous Effect of the Invention

In the hydrogen gas sensor of the present invention, electromotive force value varies in proportion to hydrogen gas concentration within a wide range from low concentration to high concentration to be able to determine the hydrogen gas concentration with a high degree of accuracy. In addition, the hydrogen gas sensor of the present invention has advantages that a required time for hydrogen detection is short, structure is simple, miniaturization is easy, manufacturing cost is low, and a self-checking of breakdown and abnormality in the sensor can be conducted since an inherent electromotive force value is indicated even at hydrogen gas concentration of zero. The hydrogen gas sensor of the present invention can be suitably used in hydrogen energy utilization system as typified by fuel cell and hydrogen-fueled engine, or in hydrogen station where hydrogen is manufactured, transported, stored, filled, or the like.

### BRIEF DESCRIPTION OF DRAWING

FIG. 1 is diagrams for showing a framework of one embodiment of the hydrogen gas sensor of the present invention.

FIG. 2 is diagrams for showing a framework of the other embodiment of the hydrogen gas sensor of the present invention.

FIG. 3 is a diagram for showing a framework of the other embodiment of the hydrogen gas sensor of the present invention.

FIG. 4 is a graph for showing a relationship between hydrogen gas concentration and EMF (electromotive force) values in the hydrogen gas sensor of EXAMPLE 1.

FIG. 5 is a diagram for showing a framework of an experimental apparatus used in EXAMPLE2.

FIG. 6 is a graph for showing a relationship between hydrogen gas concentration and EMF (electromotive force) values in the hydrogen gas sensor of EXAMPLE 2.

### EMBODIMENTS OF THE INVENTION

Hereinafter, embodiments of the hydrogen gas sensor according to the present invention are explained referring to figures. These embodiments are mere exemplifications for explaining, and the present invention is not limited by these embodiments.

### Embodiment 1

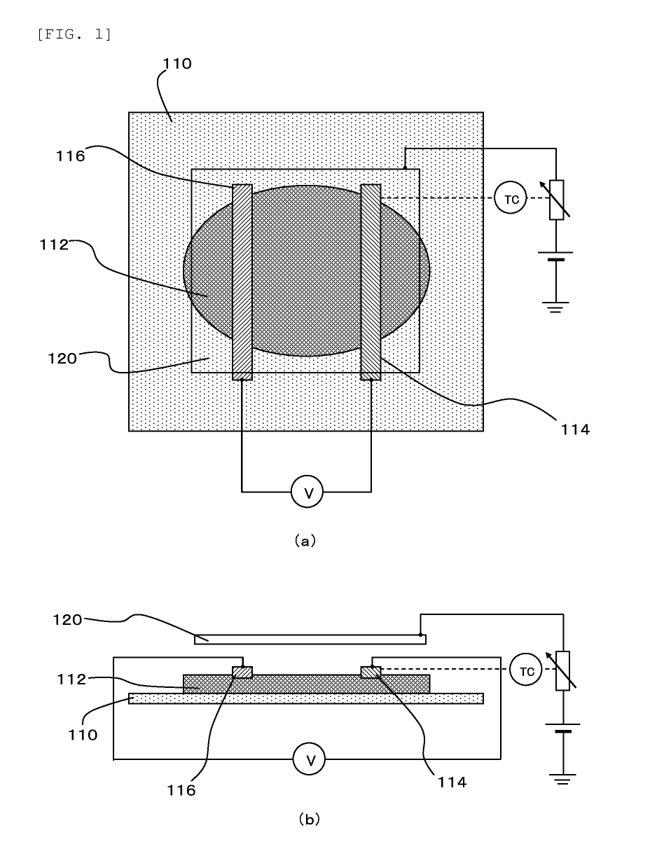

FIG. 1 is diagrams for showing a framework of EMBODIMENT 1 of the hydrogen gas sensor according to the present invention. FIG. 1(a) is a top view of the hydrogen gas sensor. FIG. 1(b) is a front view of the hydrogen gas sensor.

In the hydrogen gas sensor of EMBODIMENT 1, solid electrolyte film 112 is formed on an electrical insulating substrate 110, and a detection electrode 114 and a reference electrode 116 are placed separately from each other on the solid electrolyte film. The detection electrode 114 and the reference electrode 116 are connected with an electromotive force meter V through a conductive line. In addition, a heater 120 covering them, a power supply for the heater, a variable resistor to adjust electric power supplying to the heater, and a temperature controlling device TC which measures a temperature of the detection electrode 114 to control a resistance of the variable resistor are placed. The heater 120 is meshed pattern for example, and has both air permeability and heat-retaining property. As the other aspect, the detection electrode and the reference electrode can be placed separately from each other on the insulating substrate and the solid electrolyte film can be formed on the electrodes; or the reference electrode can be placed on the insulating substrate, the solid electrolyte film can be formed on the reference electrode and the detection electrode can be placed on the solid electrolyte film.

The detection electrode 114 and the reference electrode 116 are composed of a material having a property that hydrogen molecule doesn't voluntarily dissociate into atomic hydrogen on a surface of these electrodes in Standard State. The hydrogen gas sensor of EMBODIMENT 1 comprises the detection electrode composed of the material being T₁ in a temperature that hydrogen molecule begins to dissociate into atomic hydrogen voluntarily on a surface of the electrode in which T₁ is higher than Standard State and the reference electrode composed of the material being T₂ in a temperature that hydrogen molecule begins to dissociate into atomic hydrogen voluntarily on a surface of the electrode in which T₂ is higher than T₁.

In the hydrogen gas sensor of EMBODIMENT 1, the reference electrode and the detection electrode are maintained at a temperature T_{S} between T₁ and T₂. Hydrogen molecule voluntarily dissociates into atomic hydrogen only on a surface of the detection electrode 114 when a sample gas containing hydrogen gas is introduced into the hydrogen gas sensor maintained at the temperature T_{S}. Hydrogen molecule doesn't voluntarily dissociate into atomic hydrogen on a surface of the reference electrode 116. As a result, electromotive force is generated corresponding to hydrogen gas concentration between the detection electrode and the reference electrode. Hydrogen gas concentration can be determined by measuring the value of the electromotive force with an electromotive force meter. In conventional EMF hydrogen gas sensor which uses a detection electrode composed of a material having a property that hydrogen molecule voluntarily dissociates into atomic hydrogen on a surface of the electrode at Standard State, sensitivity is low in range of a high concentration since the electromotive force value varies in proportion to a logarithm of the hydrogen gas concentration. On the other hand, in the hydrogen gas sensor of the present invention, hydrogen can be detected in the wide range from low concentration to high concentration by the same sensitivity since the electromotive force value varies in proportion to the hydrogen gas concentration.

### Embodiment 2

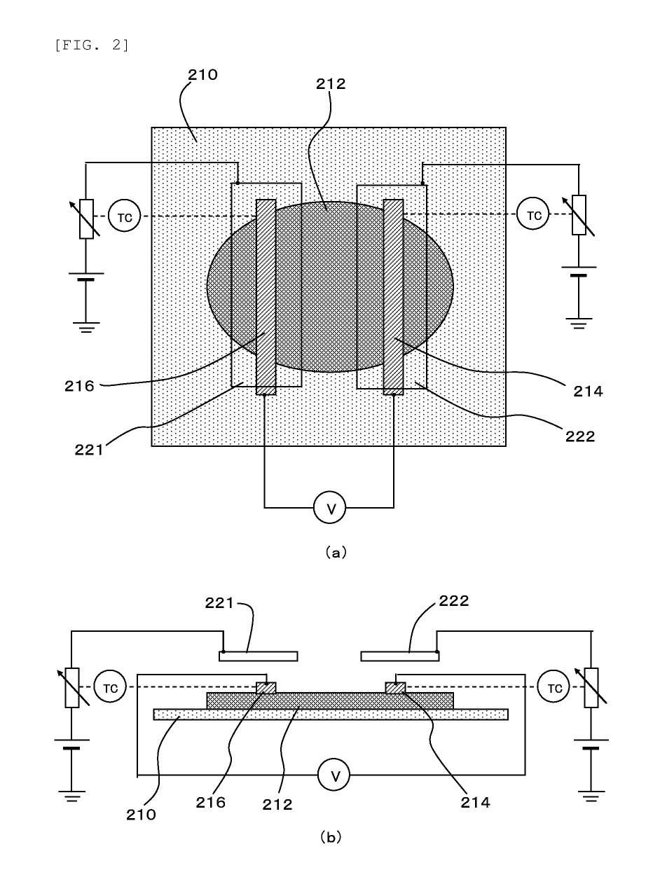

FIG. 2 is diagrams showing a framework of EMBODIMENT 2 of the hydrogen gas sensor according to the present invention. FIG. 2(a) is a top view of the hydrogen gas sensor. FIG. 2(b) is a front view of the hydrogen gas sensor. The hydrogen gas sensor has the same structure as the hydrogen gas sensor of EMBODIMENT 1 except that a detection electrode 214 and a reference electrode 216 are made from same material, and a heater 222 for the detection electrode and a heater 221 for the reference electrode are independently controlled to maintain a temperature of the detection electrode 214 and a temperature of the reference electrode 216 independently.

That is, in the hydrogen gas sensor of the EMBODIMENT 2, a solid electrolyte film 212 is formed on an insulating substrate 210, and the detection electrode 214 and the reference electrode 216 are placed on the solid electrolyte film 212 with separating from each other. The detection electrode 214 and the reference electrode 216 are connected with an electromotive force meter V through a conductive line. In addition, a heater 222 covering the detection electrode 214, a heater 221 covering the reference electrode 216, and temperature controlling devices TC for individually controlling a temperature of the detection electrode 214 and a temperature of the reference electrode 216 are provided.

The detection electrode 214 and the reference electrode 216 are composed of the same material having a property that hydrogen molecule doesn't voluntarily dissociate into atomic hydrogen on a surface of these electrodes in Standard State. That is, the hydrogen gas sensor of the EMBODIMENT 2 comprises the detection electrode and the reference electrode which are composed of the material being T_{O} in a temperature that hydrogen molecule begins to dissociate into atomic hydrogen voluntarily on a surface of the electrodes in which T_{O} is higher than Standard State.

And, the reference electrode is maintained at a temperature T_{R} lower than T_{O} and the detection electrode is maintained at a temperature T_{D} higher than T_{O}. Hydrogen molecule voluntarily dissociates into atomic hydrogen only on a surface of the detection electrode 214 when the sample gas containing hydrogen gas is introduced into the hydrogen gas sensor maintained in such temperature state. Hydrogen molecule doesn't voluntarily dissociate into atomic hydrogen on a surface of the reference electrode 216. As a result, an electromotive force change corresponding to hydrogen gas concentration occurs between the detection electrode and the reference electrode. A hydrogen gas concentration can be determined by measuring a value of the electromotive force with an electromotive force meter.

### Embodiment 3

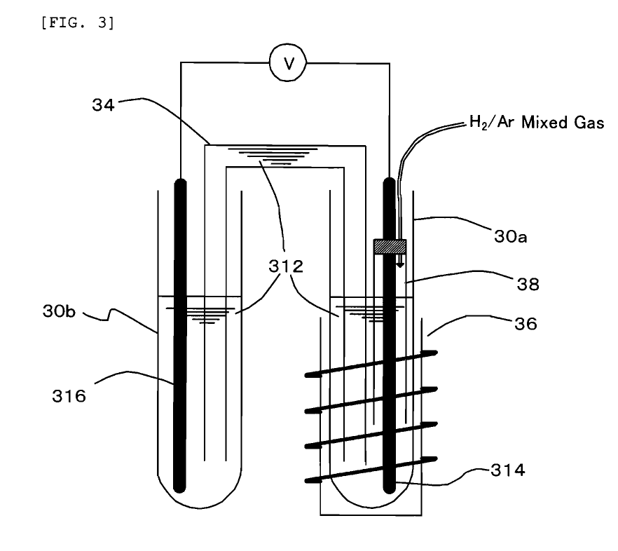

FIG. 3 is a diagram for showing a framework of EMBODIMENT 3 of the hydrogen gas sensor of the present invention. In the hydrogen gas sensor of EMBODIMENT 3, a liquid electrolyte 312 is used for the electrolyte. The liquid electrolyte 312 is get into two bottomed containers 30a and 30b, and a pipe 34 is connected between the containers. A detection electrode 314 is inserted into the container 30a and is contacted with the liquid electrolyte 312. The detection electrode 314 and reference electrode 316 are composed of the same material having a property that hydrogen molecule doesn't voluntarily dissociate into atomic hydrogen on a surface of these electrodes in Standard State. The reference electrode 316 is inserted into the container 30b and is contacted with the liquid electrolyte 312. The detection electrode 314 and the reference electrode 316 are connected with an electromotive force meter V through a conductive line. The container 30a is placed in a heating furnace 36 to control a temperature of the detection electrode 314 to not less than a temperature that hydrogen molecule begins to dissociate into atomic hydrogen voluntarily on a surface of the electrode. The container 30b is cooled by air to control a temperature of reference electrode 316 to less than a temperature that hydrogen molecule begins to dissociate into atomic hydrogen voluntarily on a surface of the electrode. The detection electrode 314 is housed in a tube 38 having a closure, and an inner space of the tube 38 is substituted with a sample gas containing hydrogen, and an electromotive force value corresponding to hydrogen gas concentration can be measured.

### EXAMPLES

### Example 1

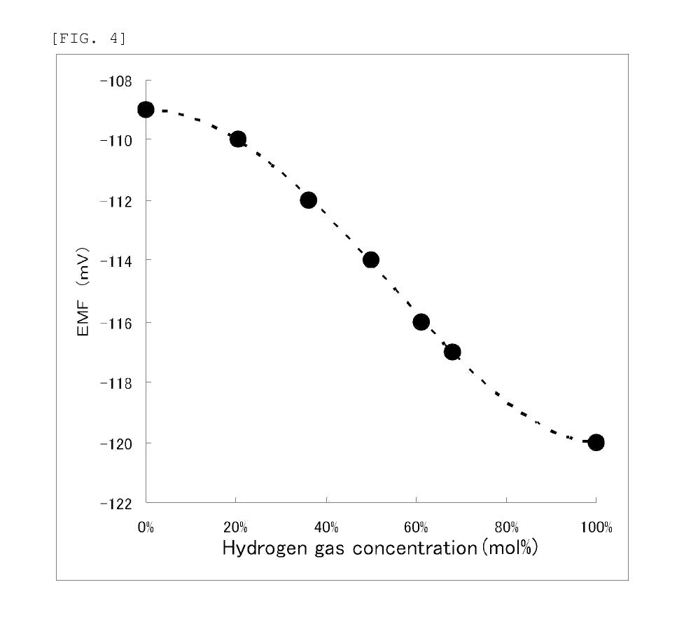

A hydrogen gas sensor having the structure as shown in FIG. 3 was assembled. As liquid electrolyte 312, 85% phosphoric acid was used. The electrodes made of tungsten were used as detection electrode 314 and reference electrode 316. The detection electrode 314 was maintained at a temperature of 85° C. The reference electrode 316 was maintained at a temperature of 25° C. An electromotive force (EMF) value was measured when mixed gas of hydrogen and argon having a prescribed molar ratio had been put into the tube 38. The result is showed in FIG. 4. In the hydrogen gas sensor of the present invention, an electromotive force varies in proportion to the hydrogen gas concentration as shown in FIG. 4. Hereby, it is understood that hydrogen gas can be detected by almost the same sensitivity within a range from low concentration to high concentration.

### Example 2

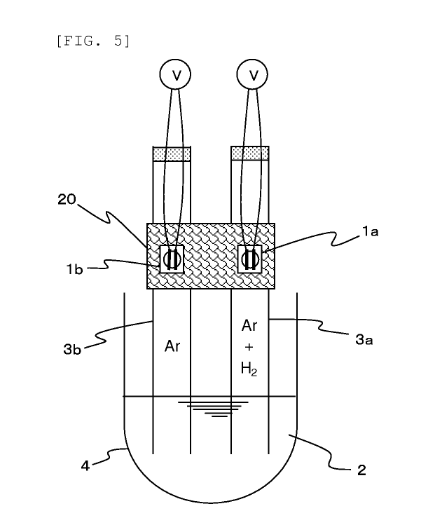

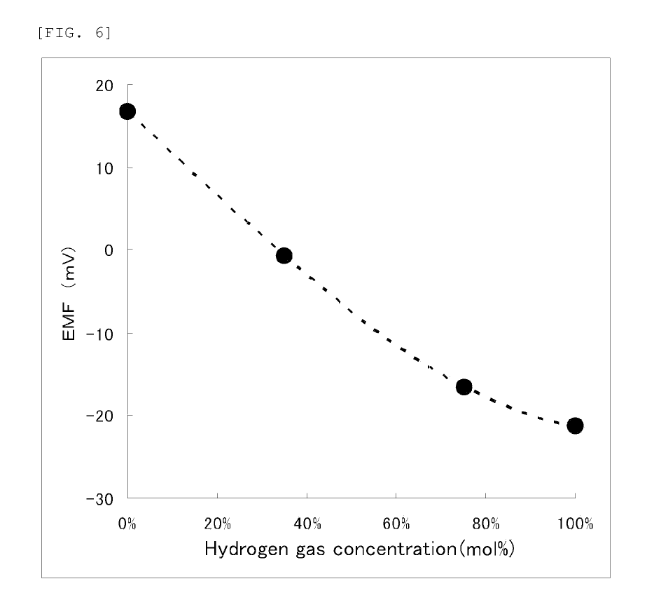

Two hydrogen gas sensors 1a and 1b having the structure as shown in FIG. 1 were assembled. A phosphotungstic acid was used as the solid electrolyte 112. An electrode made of tungsten was used as the detection electrode 114. An electrode made of silver was used as the reference electrode 116. A property of the hydrogen gas sensor was measured with the experimental apparatus as shown in FIG. 5. The hydrogen gas sensors were provided to inside of tubes 3a and 3b one by one. Argon gas was enclosed in the tube 3b. Mixed gas of hydrogen and argon having a prescribed molar ratio was enclosed in the tube 3a. Purified water was put into a container 2 to even out the humidity in the tubes 3a and 3b. Hydrogen gas sensors 1a and 1b were maintained at a temperature of 85° C. by heating with the heater 20. At that time, the value of a generated electromotive force (EMF) was measured. Measuring an EMF in the tube 3b enclosing argon gas is for a temperature compensation of the electromotive force value. The result is shown in FIG. 6. In the hydrogen gas sensor of the present invention, the electromotive force varies in proportion to hydrogen gas concentration as shown in FIG. 6. Hereby, it is understood that hydrogen gas can be detected by almost the same sensitivity within a range from low concentration to high concentration.

### DESCRIPTION OF SYMBOLS

112, 212, and 312: Electrolyte
114, 214, and 314: Detection electrode
116, 216, and 316: Reference electrode
120, 221, and 222: Heater

1. A hydrogen gas sensor comprising:
a detection electrode,
a reference electrode, and
an electrolyte contacting with these electrodes;
wherein the reference electrode and the detection electrode are composed of a material having a property that hydrogen molecule doesn't voluntarily dissociate into atomic hydrogen on a surface of the electrodes in Standard State;
wherein hydrogen gas is detected by an electromotive force generated between the reference electrode and the detection electrode while at least the detection electrode is maintained at a temperature of not lower than a temperature that hydrogen molecule begins to dissociate into atomic hydrogen voluntarily on a surface of the detection electrode.

2. The hydrogen gas sensor according to claim 1,
wherein the detection electrode is composed of the material being T₁ in the temperature that hydrogen molecule begins to dissociate into atomic hydrogen voluntarily on a surface of the detection electrode in which T₁ is higher than Standard State, and
wherein the reference electrode is composed of the material being T₂ in a temperature that hydrogen molecule begins to dissociate into atomic hydrogen voluntarily on a surface of the reference electrode in which T₂ is higher than T₁.

3. The hydrogen gas sensor according to claim 2, wherein the reference electrode and the detection electrode are maintained at a temperature T_{S} between T₁ and T₂.

4. The hydrogen gas sensor according to claim 1, wherein a temperature of the detection electrode is higher than a temperature of the reference electrode.

5. The hydrogen gas sensor according to claim 1,
wherein the reference electrode and the detection electrode are composed of the material being T_{O} in the temperature that hydrogen molecule begins to dissociate into atomic hydrogen voluntarily on a surface of the electrodes in which T_{O} is higher than Standard State,
wherein the reference electrode is maintained at a temperature T_{R} lower than T_{O}, and the detection electrode is maintained at a temperature T_{D} higher than T_{O}.

6. The hydrogen gas sensor according to claim 1,
wherein the detection electrode and the reference electrode are composed of the material having an electromotive force of less than 0.8 V in a cell composed of H₂(−)|50 mol/m³ H₂SO₄|the material (+) on Standard State.

7. The hydrogen gas sensor according to claim 1,
wherein the detection electrode and the reference electrode are composed of the at least one material selected from the group consisting of simple substance metal of tungsten, nickel, titanium, copper, silver, or aluminum; alloy comprising tungsten, nickel, titanium, copper, silver, and/or aluminum; metal hydride comprising tungsten, nickel, titanium, copper, silver and/or aluminum; and organic electrically conductive material.

8. The hydrogen gas sensor according to claim 1, wherein the reference electrode is composed of metal hydride.

9. The hydrogen gas sensor according to claim 1, wherein the electrolyte is a solid electrolyte.

10. The hydrogen gas sensor according to claim 1, wherein the electrolyte is composed of phosphotungstic acid or phosphomolybdic acid.

11. The hydrogen gas sensor according to claim 1, further comprising a unit for controlling each temperature of the reference electrode and the detection electrode.

12. The hydrogen gas sensor according to claim 1, further comprising a temperature compensation unit.

13. The hydrogen energy utilization system comprising the hydrogen gas sensor according to claim 1.
